(19) United States
(12) Patent Application Publication
(10) Pub. No.: US 2007/0219910 A1
(43) Pub. Date: Sep. 20, 2007

(54) Providing a limited use syndicated media to authorized users

(75) Inventor: Ronald Martinez, San Francisco, CA (US)

Correspondence Address: GREENBERG TRAURIG, LLP, MET LIFE BUILDING, 200 PARK AVENUE, NEW YORK, NY, 10166, US

(73) Assignee: YAHOO! INC., Sunnyvale, CA (US)

(21) Appl. No.: 11/450,184

(22) Filed: Jun. 9, 2006

Related U.S. Application Data
(63) Continuation-in-part of application No. 11/367,232, filed on Mar. 2, 2006.

(51) Int. Cl. H04L 9/00

(52) U.S. Cl. 705/51

(57) ABSTRACT

A system and method for providing a limited use syndicated media item to authorized users. In one embodiment, a universal resource identifier that identifies the syndicated media item may be limited to a predetermined number of times it may be accessed by a particular user. In one embodiment, the limited use URL may or may not be associated with an already authorized media item. In another example, the URL may be limited to being accessed a predetermined number of times during a predetermined period of time, such as no more than three times a day. In a further example, the URL may be limited to a predetermined number of instances the URL may be accessed or distributed by a user. In one embodiment, once the predetermined threshold has been met, further attempts to access will result in the extent of access being affected.

### CROSS-REFERENCE TO RELATED APPLICATION

This application claims the benefit of and is a continuation-in-part of U.S. application Ser. No. 11/367,232 filed Mar. 2, 2006 entitled PROVIDING SYNDICATED MEDIA TO AUTHORIZED USERS, which is hereby incorporated herein by reference.

### TECHNICAL FIELD

This disclosure is directed to computers and computer applications and, more particularly, to systems and methods of delivering content to an authorized syndication subscriber.

### BACKGROUND

Real Simple Syndication (RSS) and other Internet syndication schemes allow Internet users to aggregate the content provided by a plurality of different websites into a single webpage and/or program so that the user does not have to continuously visit a large number of sites. The user can subscribe to a content provider's syndication feed using a syndication aggregator, such as, for example, My Yahoo!, which is provided by Yahoo! Inc. of Sunnyvale, Calif. Syndication protocols allow content providers to transmit a variety of different content. For example, an RSS feed can be used to transmit the latest headlines on a news website and can also be used to transmit audio and video.

One problem for some content providers, particularly of provider's of large media files, is that success leads to an open-ended expense in terms of the cost of hosting the content. As more people download the content through their aggregators, the more money the content provider has to pay to support the hosting of the content. In addition, it takes a large amount of time and effort to continuously create new content in a timely fashion and with sufficient quality. Furthermore, in an effort to obtain paying members of an Internet service, a content provider may want to limit some syndicated content to paying members.

### SUMMARY

There is a desire for a system and method to limit syndicated content to authorized users. More specifically, in one case, content providers desire a system and method to receive payment for media distributed through a syndication medium, so they can pay for hosting content and for producing new media. Additionally, there is a desire for an authorization system and method that can be provided by a third party so that the content provider or the content provider's host does not have to make substantial upgrades to their website. The present disclosure satisfies these and other needs, which will be apparent from the teachings herein.

In one embodiment, a method of authorizing a syndicated media provider to send a limited use syndicated media item to a syndication subscriber comprises receiving a first message from the syndication subscriber, the first message comprising a syndication subscriber identifier and a syndicated media item identifier that identifies the limited use syndicated media item, the syndication subscriber receiving the limited use syndicated media item identifier using a syndication retriever that periodically requests updates from a syndicated content provider; determining whether the syndication subscriber is authorized to receive the limited use syndicated media item identified by the syndicated media identifier; and in response to a positive determination of authorization, authorizing the communication of the limited use syndicated media item to the syndication subscriber.

In a further embodiment, the method further comprises determining whether a threshold value associated with the limited use syndicated media item has been reached, wherein if the threshold value has been reached, the extent of data associated with the limited use media item that is made available to the syndication subscriber is affected, and if not reached, the extent is not limited.

In one embodiment, the syndicated subscriber obtains the syndicated media item identifier from an indicator in a syndication feed that can be resolved to retrieve the syndicated media item.

In one embodiment, the indicator is a URL to the syndicated media provider or a URL to an authorization computer.

In one embodiment, the method further comprises decrementing a counter stored in a memory if the threshold is not reached.

In one embodiment, the method further comprises, in response to a negative determination of authorization, transmitting instructions to obtain the limited use syndicated media item to the syndication subscriber.

In one embodiment, the authorization method further comprises transmitting the syndicated media item to the syndication subscriber. In one embodiment, the authorization method further comprises crediting an owner of the syndicated media item.

In one embodiment, the syndicated subscriber obtains the syndicated media item identifier from an indicator in a syndication feed that can be resolved to retrieve the syndicated media item. In one embodiment, the indicator is a URL to the syndicated media provider, and in one embodiment, the indicator is a URL to an authorization computer.

In one embodiment, if the step of determining whether the syndication subscriber is authorized leads to a negative determination of authorization, the syndication subscriber can be provided with instructions on how to obtain the syndicated media item. In one embodiment, a webpage is sent to the syndication subscriber, the webpage comprising instructions on how to pay for the desired media item.

In one embodiment, the authorization computer is the syndicated media provider. In one embodiment, the syndication retriever is a syndication aggregator.

In one embodiment, the step of authorizing the transmission of the syndicated media item to the syndication subscriber comprises transmitting a first token to the syndication subscriber, wherein the first token can be sent by the syndication subscriber to the syndicated media provider to receive the syndicated media item; receiving a second token from the syndicated media provider; and in response to a positive correlation between the first and second tokens, transmitting a second message to the syndicated media provider, the second message comprising an indication of authorization to send the syndicated media item to the syndication subscriber.

In one embodiment, the indication of authorization is a universal resource identifier that identifies the syndicated media item. In one embodiment, the first token and the second token are the same token. In one embodiment, the first token is a nonce. In one embodiment, the first token provides access to the syndicated media for a period of time. In one embodiment, the first token provides access to the syndicated media for a predetermined number of times.

In one embodiment, the universal resource identifier and/or universal resource locator that identifies the syndicated media item has a limited use. For example, the URL (or URI) may be limited to a predetermined number of times it may be accessed by a particular user. In one embodiment, the limited use URL may or may not be associated with an already authorized media item. In another example, the URL may be limited to being accessed a predetermined number of times during a predetermined period of time, such as no more than three times a day. In a further example, the URL may be limited to a predetermined number of instances the URL may be accessed or distributed by a user. In one embodiment, once the predetermined threshold has been met, further attempts to access will result in a user message or only limited content being available to the user.

In one embodiment, the user may directly receive and the limited use URL provided at the point of authentication, and the enter it directly into his syndication retriever, as opposed to having this process all happen as a result of the interaction between various pieces of software and/or components.

In one embodiment, a URL database stores the limited use URL which resolves to actual URL within the database. Further, a user information database also comprises or has access to a counter associated with each user ID and feed so that the counter is first checked to see if the limited use URL's predetermined threshold has been exceeded. In one embodiment, the memory storing the threshold value maybe stored in a separate memory within the user information database. In one embodiment, the counter stores the number of uses remaining for a particular URL. Thus, in this embodiment, each time the URL is accessed or used, the counter decrements by a unit. When the counter reaches the limit it has decremented to a zero value and thus, the threshold has been met.

In one embodiment, if the threshold has been met, the extent of displayed data associated with the limited use media item and the limited use URL is affected. For example, in one embodiment, if the threshold has been met, the extent of displayed data associated with the limited use media item may comprise a message indicating that the threshold has been met being sent to the user, a message informing the user that they must get authorization in order to see the media may be sent, or only a portion of the limited use media item may be made available, and/or any combination of the aforementioned options.

In one embodiment, the step of authorizing the transmission of the syndicated media item to the syndication subscriber comprises, requesting a token from the syndicated media provider; and transmitting the token to the syndication subscriber, wherein the token can be sent by the syndication subscriber to the syndicated media provider to receive the syndicated media item.

In one embodiment, the step of authorizing the transmission of the syndicated media item to the syndication subscriber comprises, selecting a token from a plurality of pre-approved tokens previously received from the syndicated media provider; and transmitting the token to the syndication subscriber, wherein the token can be sent by the syndication subscriber to the syndicated media provider to receive the syndicated media item.

In one embodiment, a positive determination of authorization is made if the subscriber has viewed a predetermined number of commercials. In one embodiment, a positive determination of authorization is made if the subscriber belongs to another service. In one embodiment, a positive determination of authorization is made if the subscriber can pay for the syndicated media item.

In one embodiment, the step of determining whether the syndication subscriber is authorized to receive the syndicated media item further comprises, requesting a subscriber payment status from a network content provider; and receiving a response comprising the syndication subscriber's payment status. In one embodiment, in response to a negative determination of authorization, the authorization method further comprises requesting payment from the syndication subscriber. In one embodiment, the syndication subscriber guarantees payment through a credit card. In one embodiment, the authorization method further comprises debiting a stored value account associated with the syndication subscriber.

In one embodiment, an authorization computer and the network content provider are operated by different entities.

In one embodiment, the step of determining whether the syndication subscriber is authorized to receive the syndicated media item further comprises, accessing a user database; using the syndication subscriber identifier to find a subscriber's information on the user database; and using the syndicated media identifier to determine from the subscriber's information whether the user is authorized to receive the syndicated media item.

In one embodiment, the step of determining whether the syndication subscriber is authorized to receive the syndicated media item comprises determining whether a syndication subscriber's subscription is in good standing.

In one embodiment, the syndicated media provider performs the step of determining whether the syndication subscriber is authorized to receive the syndicated media item identified by the syndicated media identifier.

In one embodiment, the syndicated media provider is another syndication subscriber.

In one embodiment, the syndicated media item is syndicated using a real simple syndication protocol.

In one embodiment, the syndication aggregator is operated by a network content provider.

In one embodiment, the syndication aggregator is operated by the syndication subscriber.

In one embodiment, the syndicated media provider performs the step of authorizing the transmission of the syndicated media item to the syndication subscriber.

In one embodiment, the syndicated media is a video. In one embodiment, the syndicated media is part of a podcast. In one embodiment, the syndicated media is a blog. In one embodiment, the syndicated media is an audio file. In one embodiment, the syndicated media is computer code.

A commercial syndication computer, implemented according to one embodiment of the disclosure comprises, a processing module; a communication module; and memory. The memory comprises, message retrieval computer code, the message retrieval computer code configured to receive a first message from a syndication subscriber, the first message comprising a syndication subscriber identifier and a syndicated media item identifier that identifies a syndicated media item, the syndication subscriber receiving the syndicated media item identifier from a syndication aggregator; and authorization computer code, the authorization computer code configured to determine whether the syndication subscriber is authorized to receive the syndicated media item identified by the syndicated media identifier, and to authorize the transmission of the syndicated media item to the syndication subscriber if a positive determination is made.

In one embodiment, the commercial syndication computer further comprises a user database, the user database comprises user information indicating an authorization status for the syndicated media item.

In one embodiment, the memory further comprises the syndicated media item. In one embodiment, the memory further comprises transmission computer code, the transmission computer code configured to transmit the syndicated media item to the syndication subscriber.

In one embodiment, a method of displaying a syndication feed to a syndication subscriber is described. In one embodiment, the method comprises examining the syndication feed to determine whether a link to a media item is a link to a premium media item, the syndication subscriber requires authorization to receive the premium media item; and differentiating the link to the premium media item from a link to a non-premium media item when displaying the syndication feed to the syndication subscriber.

In one embodiment, the limited use URL may or may not be a premium media item.

In one embodiment, the link to the premium media is differentiated from the link to a non-premium media item by placing the feed in a section dedicated to premium content. In one embodiment, the link to the premium media is differentiated from the link to a non-premium media item by displaying an icon adjacent to the link to the premium media item. In one embodiment, the icon displayed is selected from a plurality of icons, each icon identifying a different payment structure for the premium media item.

In one embodiment, a link to a media item is a link to a premium media item if the link points to an authorization website rather than a direct link to the media item. In one embodiment, the link to a premium media item is provided in an <enclosure>subelement of the syndication feed. In one embodiment, the link to an authorization website further comprises a syndicated media item identifier.

In one embodiment a syndication feed rendering comprises a link to a premium media item; and an indicator, that informs a syndication subscriber that the link to a premium media item requires authorization before the syndication subscriber can receive the premium media item. In one embodiment, the indicator is a section dedicated to premium content. In one embodiment, the indicator is an icon displayed adjacent to the link to the premium media item.

In one embodiment, a syndication feed comprises a media item declaration; and an indicator within the media item declaration that can be resolved to retrieve a media item, the indicator comprising a link to an authorization computer and a media item identifier. In one embodiment, the authorization computer is a media item provider. In one embodiment, the media item declaration is an <enclosure> subelement of the syndication feed. In one embodiment, the authorization computer can provide instructions to a syndicated media subscriber in the event the syndicated media subscriber is unauthorized to receive the media item.

Other objects and features of the disclosure will become apparent from the following detailed description, considered in conjunction with the accompanying drawing figures. It is understood however, that the drawings are designed solely for the purpose of illustration and not as a definition of the limits of the disclosure.

### BRIEF DESCRIPTION OF THE DRAWING FIGURES

The drawing figures are not to scale, are merely illustrative, and like reference numerals depict like elements throughout the several views.

FIG. 1 illustrates a system implemented according to an embodiment.

FIG. 2 illustrates another system implemented according to an embodiment.

FIG. 3 illustrates a syndicated media subscriber authorization method implemented according to one embodiment.

FIG. 4 illustrates a method for authorizing the transmission of a syndicated media item to a syndicated media subscriber, implemented according to one embodiment.

FIG. 5 illustrates another method for authorizing the transmission of a syndicated media item to a syndicated media subscriber, implemented according to one embodiment.

FIG. 6 illustrates an additional method for authorizing the transmission of a syndicated media item to a syndicated media subscriber implemented according to one embodiment.

FIG. 7 illustrates a syndicated media aggregation method implemented according to one embodiment.

FIG. 8 illustrates an example of a syndicated media aggregation webpage implemented according to one embodiment.

FIG. 9 illustrates a method for accessing a limited use URL associated with a media item.

### DETAILED DESCRIPTION OF EXEMPLARY EMBODIMENTS

There will now be shown and described in connection with the attached drawing figures several embodiments of a system and method of providing syndicated media to authorized syndication subscribers.

The term premium media as used herein, unless otherwise specified expressly or by context, is intended to have a broad non-limiting definition, and refers, without limitation, to media that is intended to be of limited or controlled distribution, preferably to authorized or targeted users, as opposed to any user of a network. The term premium media, as used herein does not necessarily refer to the quality of a media item.

The term Internet as used herein, unless otherwise specified expressly or by context, is intended to have a broad non-limiting definition, and refers, without limitation, to a computer network and any other group of computers communicatively coupled together.

The term Internet content provider as used herein, unless otherwise specified expressly or by context, is intended to have a broad non-limiting definition, and refers, without limitation, to an Internet provider of content and services, such as, for example, news, email, directions, instant messaging, syndication aggregation and other content and services. These services can be provided through an Internet browser, a toolbar, a plug-in to an Internet browser, a computer application, and any other module executable to perform instructions on a computer. One example of an Internet content provider is Yahoo! inc. of Sunnyvale Calif.

Internet syndication is a method of delivering content to Internet users. Using a syndication aggregator, an Internet user can subscribe to a plurality of different Internet sites and automatically receive new content from those sites without having to individually visit all those sites. Therefore, Internet syndication is a great way to receive the most current information and media.

In one embodiment of the disclosure, media accessible from a syndication feed is limited to authorized users. A syndicated media provider may wish to limit access to certain syndicated media for a plurality of different reasons, for example, the syndicated media provider may want to receive payment for certain media items, provide access to media in exchange for watching commercials, provide access to media to members of a particular service, and for other reasons.

Emerging artists with a limited amount of funds may not be able to afford the costs of hosting or otherwise providing their media for Internet users to download. To make matters worse, the more popular an artist's product becomes, the more it is downloaded and the more it costs the artist to host their work. The inability to pay for their success may discourage artist from using Internet syndication to disseminate their works, since more subscribers means more costs. In one embodiment, media items accessed through a syndication feed can be limited to user's who have paid for the content. Thus, the content provider can use the funds collected to host their work and to create new work.

In one embodiment, syndication subscribers who wish to access premium media have an account with an authorization service provider. The authorization service provider maintains a subscriber database, which can store user information, which in one embodiment is associated with a unique user identifier. In one embodiment, a syndication subscriber can have a credit card or other payment entity associated with the account. The card is kept on file and a time-based charge is applied to the card, such as, for example, a monthly, weekly, or daily payment. In one embodiment, the card can be charged on a per item basis. The user information can also comprise the premium media that the subscriber is authorized to access. For example, the user may be authorized to access specific media items, all the media items from a specific content provider, any media item as long as they have a positive balance, any media item as long as they have a valid card on file, a number of commercials watched, and other information for determining whether a subscriber is authorized to receive premium media.

In one embodiment, a syndication subscriber authorization service can be provided by a third party, for example, in exchange for a fixed fee and/or part of the revenue generated from a media item. In one embodiment, an Internet content provider, such as, for example, Yahoo! of Sunnyvale, Calif., can add an authorization system to its Internet services and provide authorization for independent content providers. For example, Yahoo!'s existing member infrastructure immediately provides a wide audience that already possesses usernames, passwords and user databases (UDB) that can be used to store syndication subscriber information such as, for example, the subscriber's authorized media, payment information, advertisements watched, and other information. In one embodiment, the content provider can provide the media, as well as be its own authorization service provider.

In one embodiment, a syndication rendering distinguishes premium media from other syndicated media. For example, a syndication rendering can group premium media in a special section, and/or the syndication rendering can place an icon next to premium media items. In one embodiment, premium media can be highlighted, bolded, italicized or otherwise distinguished from other syndicated media. Some media item may cost different amounts, so the icon can be a price, or the rendering can group media items by price.

In one embodiment, a syndication rendering distinguishes limited use URLS and their associated media items. For example, a syndicating rendering can group limited use media items in a special section, and/or the syndication rendering can place an icon next to the limited use media items. In another embodiment, the number of uses left for a particular media item may be displayed.

In one embodiment, a syndication rendering module can distinguish between a link to a premium media item from a link to other syndicated media because the link to premium media comprises a link to an authorization service and a premium media identifier rather than a direct link to the premium media item itself. For example, a typical <enclosure> item in an RSS feed comprises a direct link to the media item, such as, http://foofoo/video.mpg. Thus, a syndicating rendering module renders that link as standard media. If the <enclosure> item comprises a link to an authorization service and a media item identifier, such as, http://authorize.yahoo.com/18jh83huiwf94fhqr7fe, then the syndication rendering module renders the link as premium media. In one embodiment, the <enclosure> item comprises a link to a content provider and a media item identifier, such as, http://conentprovider.com/18jh83huiwf94fhqr7fe.

When a user selects a premium media item link, the user's syndicated media retriever presents the authorization service provider with the media item identifier, a subscriber identifier and optionally a password. If the link to the authorization service provider is not part of the feed, then the syndicated media retriever can ask the subscriber for the information, and/or the syndicated media retriever may use a default authorization service provider. The subscriber identifier and/or password can be requested from the user when they opened their syndication retriever, when the user selected the premium media item link, from the user's computer, from a cookie, and through other subscriber information retrieval methods. In one embodiment, the user may be asked to subsequently re-enter a password for added security.

Once the authorization service provider receives the information, it determines if the identified subscriber is authorized to receive the identified media item. For example, in one embodiment, the authorization service provider can access a subscriber's UDB, which comprises a list of media items that the subscriber is authorized to receive, and/or a valid credit card. The authorization service provider may, in one embodiment, run a decrypting method on the media item identifier received from the user's syndicated media retriever.

In one embodiment, if the subscriber is authorized to receive the media item, then the authorization service provider returns a one-time token to the syndicated media retriever. The term token, as used herein is intended to have a broad non limiting definition, including but not limited to a link, a nonce, a certificate, and/or anything else that can be used to access premium media. The token can be, in one embodiment, a uniquely identified, single purpose string of data, which may or may not be digitally signed by the authorization service provider. The authorization service provider can also, in one embodiment, charge the subscriber's card for payment, debt a user's stored value account, or otherwise receive payment for the media item. The proceeds from the media item are shared with the content provider.

In one embodiment, the token is a link which comprises a pointer to the content provider's website. In one embodiment, the syndicated media retriever can obtain the content provider's website from the syndication rendering. In ether case, the token is sent to the content provider to obtain the premium media item. Then, the content provider contacts the authorization service provider to determine whether the token is valid. In one embodiment, the content provider also receives a media item identifier from the authorization service provider, which in one embodiment is a direct link to the media item. Now that the subscriber is authorized and the content provider knows which media item was selected by the subscriber, the content provider can send the media item to the subscriber.

In one embodiment, the authorization service provider may obtain a range of pre-established tokens from the content provider. Therefore, once the authorization service provider approves the subscriber, the authorization service provider can send the syndicated media subscriber one of the pre-established tokens. Since the tokens have been pre-established by the content provider, when a content provider receives a token from a syndicated media subscriber, it will know what media item the syndicated media subscriber is requesting and can send them that item.

In one embodiment after a syndicated media subscriber is authorized to receive the media item, the authorization service provider can request a token from the content provider. After receiving a token from the content provider, the authorization service provider can forward that token to the syndicated media subscriber. The syndicated media subscriber can then use the token to obtain the media item from the content provider.

In one embodiment, if the syndicated media subscriber is not authorized to receive the media item, the authorization service provider can send the syndicated media subscriber a rejection and instructions on how to obtain the desired media. Thus, the link provided by the content provider in a feed can lead a user either to the desired media item or to a webpage with additional information.

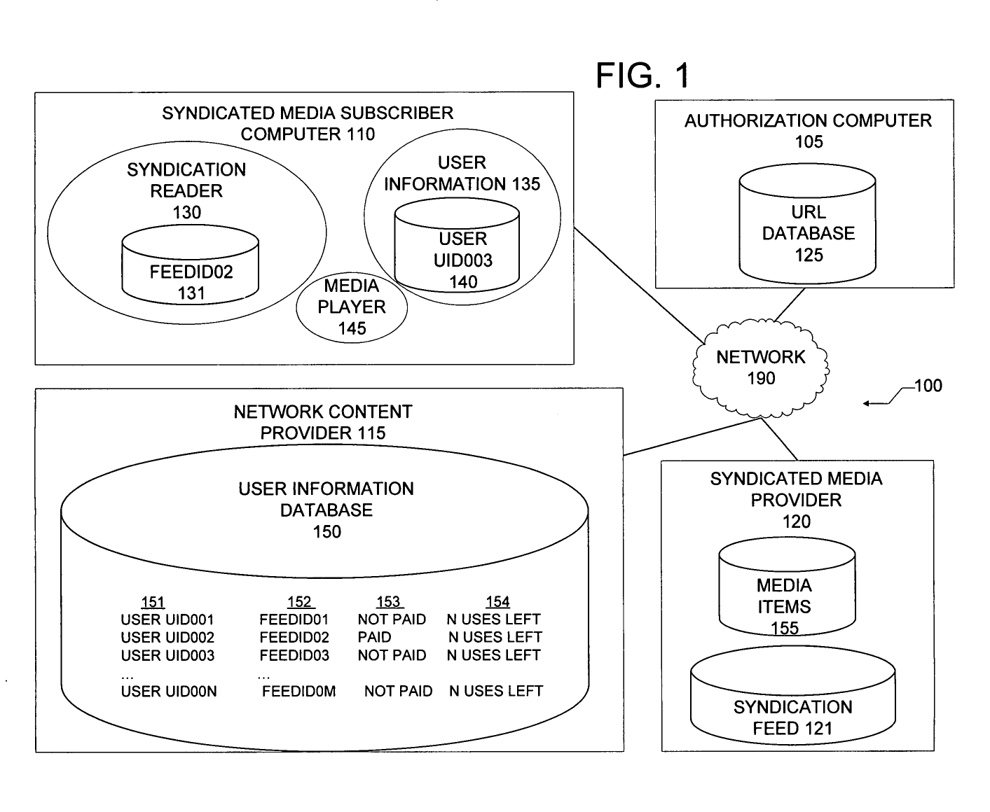

FIG. 1 illustrates an exemplary system 100 implemented according to one embodiment of the disclosure. System 100 comprises authorization computer 105, syndicated media subscriber computer 110, syndicated media provider 120 and network content provider 115 coupled together by network 190. A syndicated media subscriber can use the syndicated media computer 110 to access media from the Internet (or network 190). The syndicated media subscriber computer 110 comprises a syndication reader 130, media player 145 and user information 135. User information 135 comprises a user identifier 140, “UID003” for example in a cookie. In one embodiment, the user ID can be a preexisting ID from an Internet content provider. Syndication reader 130 comprises “FeedID02” 131.

In one embodiment, referring to FIG. 1, the URL database 125 stores the limited use URL in a file or database entry or other form which resolves to actual URL. Further, the user information database 150 also stores a counter 154 with a memory so that the counter 154 is first checked to see if the limited use URL's predetermined threshold has been exceeded. In one embodiment, the memory storing the threshold value maybe stored in a separate memory within the user information database 150. In one embodiment, the counter 154 stores the number of uses remaining for a particular URL. Thus, in this embodiment, each time the URL is accessed or used, the counter 154 decrements by a unit. When the counter 154 reaches the limit, it is decremented to a zero value and thus the threshold has been reached.

In one embodiment, if the threshold has been met, the extent of displayed data associated with the limited use media item and the limited use URL is affected. For example, in one embodiment, if the threshold has been met, the extent of displayed data associated with the limited use media item may comprise a message indicating the threshold has been met, or a message informing the user that they must get authorization in order to see the media, or, only a portion of the limited use media item may be made available, or no data, and/or any combination thereof. For example, a portion of the limited use media item may be a clip, summary, or synopsis associated with the media item but not the full item.

The network content provider 115, preferably comprises a user database 150 which can comprise a variety of different information for a syndicated media subscriber. In one embodiment, as shown in FIG. 1, the user information comprises a list of user IDs 151, and for each user ID 151, the user information comprises a list 152 of media feeds carried by the content provider 115, a corresponding list 153 indicating whether the user is authorized to receive feeds 152 or not, and if applicable, a memory storing a counter 154 of how many uses remain for a limited use URL. In one embodiment, a subscriber can browse a list of available feeds and subscribe to the feeds that interest them, knowing that these feeds comprise media items that require payment. In FIG. 1, the subscriber has paid for “FeedID02.” In one embodiment, the feed identifier can be stored in the subscriber's syndication reader 130, along with a universal resource locator (URL) for the feed.

Content for the feeds are provided by the syndicated media provider 120. In one embodiment, the syndicated media provider 120 comprises a syndication feed 121 and media items 155. In one embodiment, the media items can comprise premium media items that require authorization before they are disseminated. In one embodiment, authorization can be obtained from payment for the media item, in exchange for viewing advertisements and/or as part of another paid membership.

In one embodiment, the syndication reader 130 can be used by the syndication subscriber to subscribe to syndicated media feeds 152, stocked by the network content provider 115. In one embodiment, the syndication reader 130 can be part of a portal or other set of services offered by an Internet content provider. When the subscriber opens or logs into their syndication reader 130, the syndication reader 130 passes the Feed ID 131 and the User ID 140 to authorization computer 105, through a POST or another similar mechanism. The authorization computer 105 in turn passes these two items to network content provider 115, which passes back confirmation that User “UID003” has paid for Feed “FeedID02”. In one embodiment, the authorization computer 105 can be an externally located and operated server process, and in one embodiment, the operations of an authorization computer 105 can be implemented as a module within the network content provider 115.

Once authorization computer 105 confirms that “UID003” has paid for Feed “FeedID02”, the authorization computer 105 generates a one-time URL using a method known in the art. Then the authorization computer 105 associates the generated URL with the actual URL of the media 155 to be delivered to the subscriber's Media Player 145. The generated URL and the actual URL are then stored in a file or database entry or other form in URL Database 125. The generated URL is also returned to syndication reader 130, which in turn presents the generated URL to syndicated media provider 120. Syndicated media provider 120, presents the generated URL to authorization computer 105, which resolves the generated URL to the actual URL and returns the actual URL to syndicated media provider 120. Syndicated media provider 120, can then use the actual URL, to locate the media item in its Media items database 155, and transmit the media item to the subscriber's media player 145, where the media item may be experienced by the subscriber.

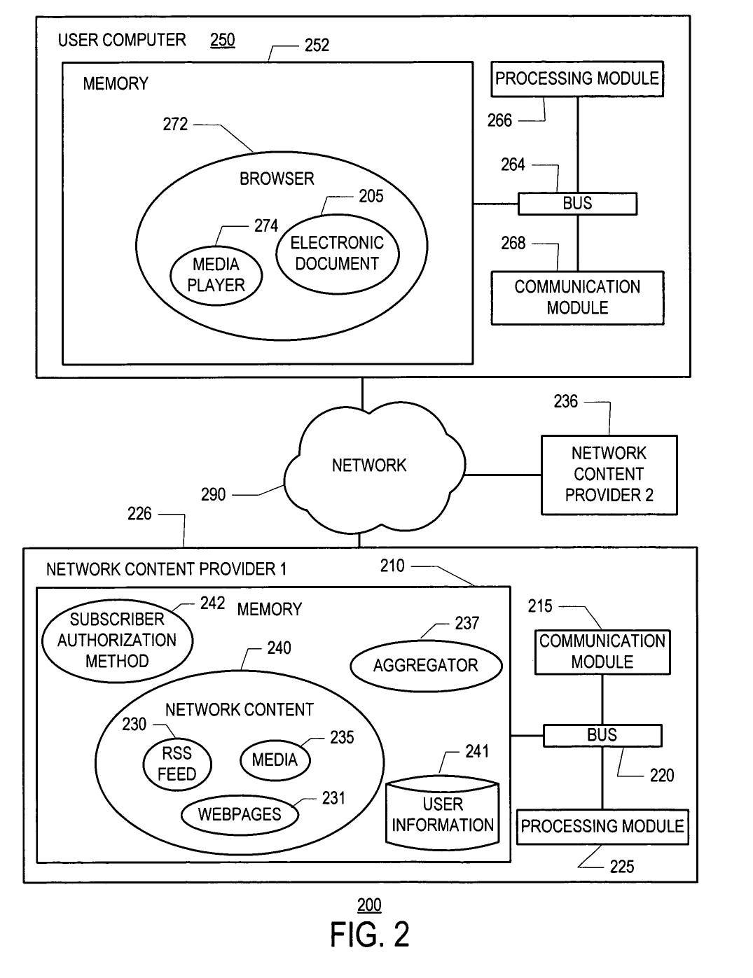

In the embodiment illustrated in FIG. 1 the authorization computer 105, the network content provider 115, and the syndicated media provider 120, are three separate modules. In alternate embodiments these three computers can be combined into one computer or in any combination of the three or more. For example FIG. 2 illustrates a system 200 wherein the network content provider 226 also performs authorization and comprises the syndicated media items.

FIG. 2 illustrates an example of a system 200 implemented according to one embodiment of the disclosure. System 200 comprises user computer 250, network content provider one 226 and network content provider two 236 coupled to network 290.

The memory of user computer 250 comprises a browser 272. The browser 272 comprises a media player 274 and an electronic document 205. In one embodiment, the media player 274 can be a plugin to the browser 272. In one embodiment, the media player can be a separate program from the browser 272. In one embodiment, the electronic document is a web page comprising an aggregation of syndicated feeds subscribed by a network user.

The memory 210 of network content provider one 226 comprises a subscriber authorization method 242, an aggregator 273, network content 240 and user information 241. The network content 240 comprises syndicated feeds 230, webpages 231 that can be accessed by network users and media 235, such as, for example, articles, videos, photos, music and other types of media.

In the system illustrated in FIG. 2, the aggregator 237 is located at the network content provider one 226. In one embodiment, the aggregator 237 can retrieve feeds from a variety of different locations on the network, for example, from the network content 240 and/or from network content provider two 236. The aggregator 237 can render these various feeds into a single webpage that can be sent to the user computer and displayed by the browser 272.

Some of the rendered feeds can comprise links to premium media. The aggregator 237 can separate feeds with links to premium media into a separate section and/or the aggregator can place an icon next to links to premium media, informing the user that, those links are special. If a user selects a premium media link, the browser 272 can send a request to the network content provider one 226 to obtain authorization for the user. Using subscriber authorization method 242, the network content provider one 226 can examine user information 241 to determine whether the user is authorized to receive the media item. If the user is authorized to receive the media item the network content provider one 226, in one embodiment, can retrieve the media 235 and send the media 235 to the user computer 250 to be played on media player 274.

In one embodiment, the universal resource identifier that identifies the syndicated media item has a limited use. For example, the URL may be limited to a predetermined number of times it may be accessed by a particular user. In one embodiment, the limited use URL may or may not be associated with an already authorized media item. In another example, the URL may be limited to being accessed a predetermined number of times during a predetermined period of time, such as for example no more than three times a day. In a further example, the URL may be limited to a predetermined number of instances the URL may be accessed or distributed by a user. In another example, the limited use URL may be limited to a predetermined time period such as a 30-day trial period. In another example, the limited use URL may be limited to a re-occurring predetermined time period such as from 12 pm-2 pm everyday or only on weekends.

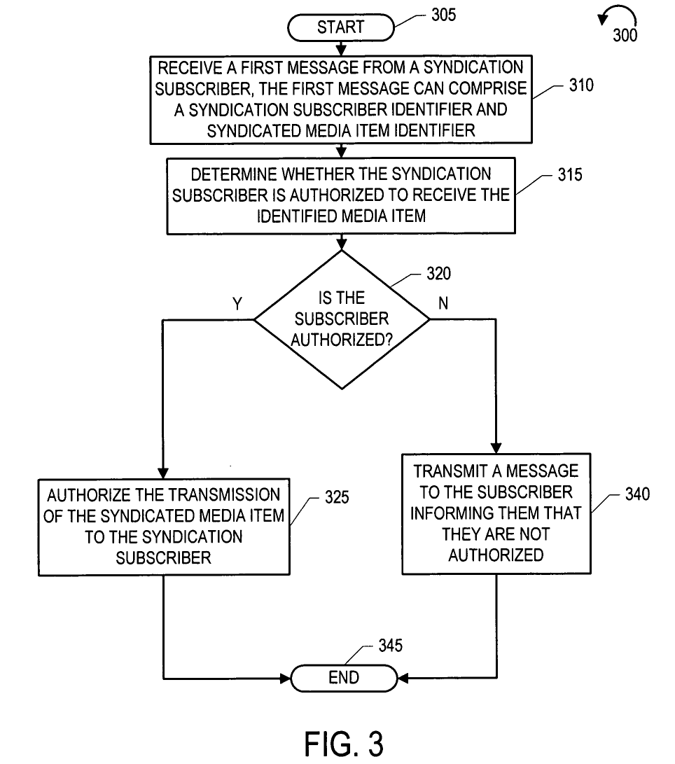

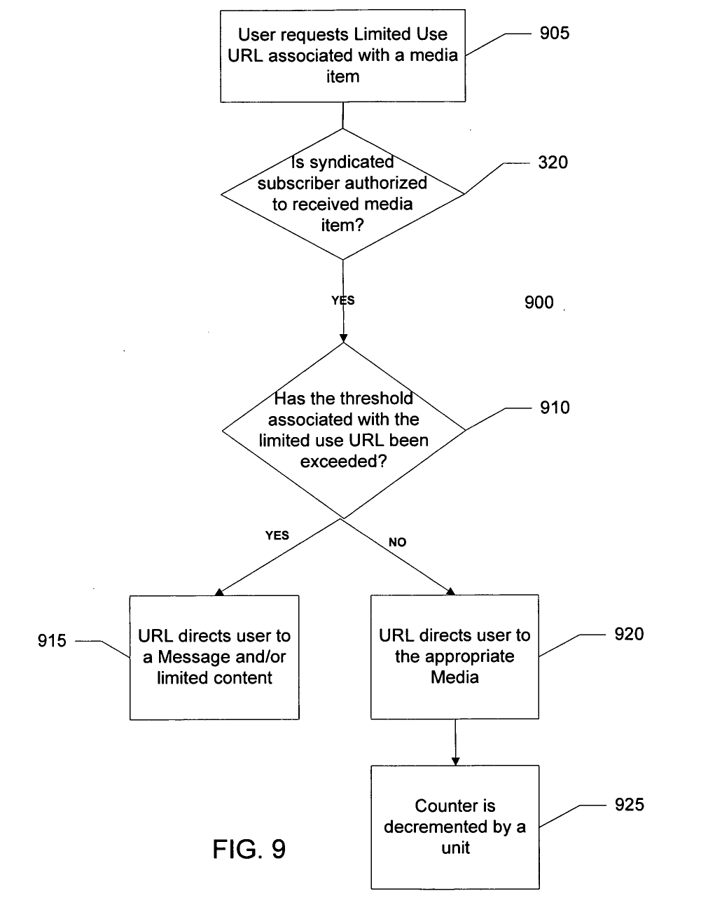

FIG. 9 illustrates one embodiment of a method 900 for accessing a limited use URL associated with a media item. Method 900 starts in step 905 where the user requests a limited use URL associated with a media item. In one embodiment, the user must be authorized 320 as discussed with reference to FIG. 3 before it is determined whether the limited use threshold has been met. Then, method 900 proceeds to step 910 where a counter 154 stored in a memory at 154 is checked to determine whether the predetermined number or threshold for the particular limited use URL has been met.

If the threshold has been met 915, meaning there are no more uses for the particular URL at that time, then the extent of displayed data associated with the limited use media item and the limited use URL is preferably affected. For example, in one embodiment, if the threshold has been met, the extent of displayed data associated with the limited use media item may comprise a message indicating the threshold has been met, which may be made available when the URL is selected or may be sent as a separate message to the user. In another embodiment, the extent of displayed data associated with the limited use media item may comprise a message informing the user that they must get authorization in order to see the media. In another embodiment, the extent of displayed data associated with the limited use media item may comprise only a portion of the limited use media item such as a feed of media, such as audio, video, or text headlines and story summary, clip, or minimal information may be returned, but the content of these will preferably inform the accessing user that they must become authorized by paying or agreeing to terms specified by the provider of the media or the operator of the syndicated media provider or authorization computer. In another embodiment, the extent of displayed data associated with the limited use media item may comprise nothing being displayed. In another embodiment, the extent of displayed data associated with the limited use media item may comprise any combination of the displayed data discussed herein such as a clip and a message to the user indicating the threshold has been met.

Returning to step 910, if the threshold has not been met 920, meaning there is at least one remaining use of the limited use URL, then the URL will direct the user to the appropriate media and in one embodiment, the counter 154 is decremented by a unit 925.

In one embodiment, the user may directly receive and the limited use URL provided at the point of authentication, and the enter it directly into his syndication retriever, as opposed to having this process all happen as a result of the interaction between various pieces of software and/or components.

FIG. 3 illustrates one embodiment of an authorization method 300 that can be implemented in one embodiment by the authorization computer 105. Method 300 starts in step 305. Then method 300 proceeds to step 310 where the authorization computer 105 receives a first message from a syndicated subscriber. The first message can comprise a syndication subscriber identifier and an identifier for the syndicated media item. In one embodiment, the syndicated media item identifier can be an encoded string that identifies the media item. Proceeding from step 310, method 300 proceeds to step 315 where the authorization computer 105 determines whether the syndicated subscriber is authorized to receive the identified media item. In one embodiment, the authorization computer 105 can contact a network content provider 115 to determine whether the user is authorized.

Following step 315, in step 320 if the subscriber is authorized to receive the media item, processing proceeds from step 320 to step 325 where the authorization computer 105 authorizes the transmission of the syndicated media item to the syndication subscriber. In one embodiment, authorization is granted by actually sending the media item to the syndication subscriber. Method 300 ends in step 345.

Returning to step 320, if the subscriber is not authorized to receive the media item, method 300 proceeds from step 320 to step 340 where the authorization computer 105 transmits a message to the subscriber informing them that they are not authorized. In one embodiment, the message may also comprise information on how to obtain access the media. For example, the syndicated subscriber may be sent to a payment webpage. Method 300 ends in step 345.

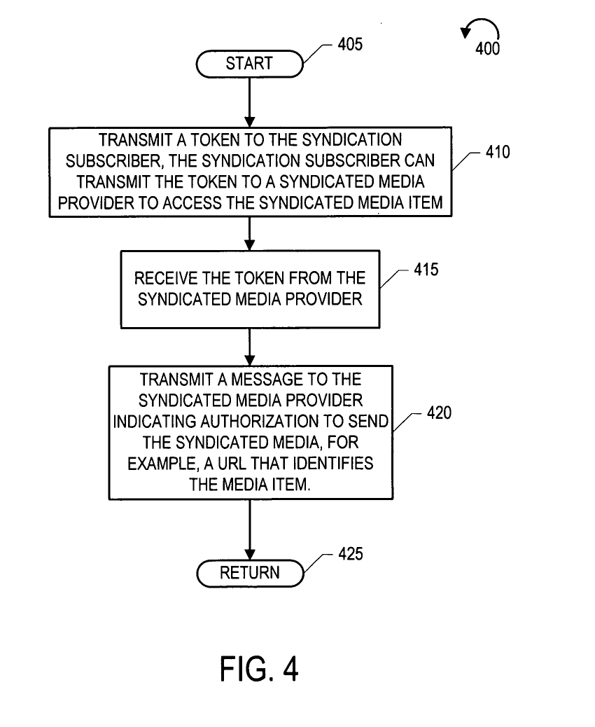

FIG. 4 illustrates a method 400 for authorizing the transmission of a syndicated media item to a syndicated media subscriber, which can be implemented as step 325 of FIG. 3. Method 400 starts in step 405. Then, in step 410, the authorization computer 105 transmits a token to the syndicated subscriber. The syndicated subscriber can then transmit the received token to the syndicated media provider 120 to access the media item. The syndicated media provider 120, in turn sends the token to the authorization computer 105 to resolve, which media item is being granted by the token. Thus, in step 415 the authorization computer 105 receives the token from the syndicated media provider 120. If the token received from syndicated media provider 120 matches the token sent to the syndicated media subscriber 110, then the authorization computer 105 transmits a message to the syndicated media provider 120 indicating authorization to send the syndicated media item to the authorized subscriber. In one embodiment, the authorization can comprise a URL that identifies the media item. Then method 400 returns in step 425, for example to method 300 of FIG. 3.

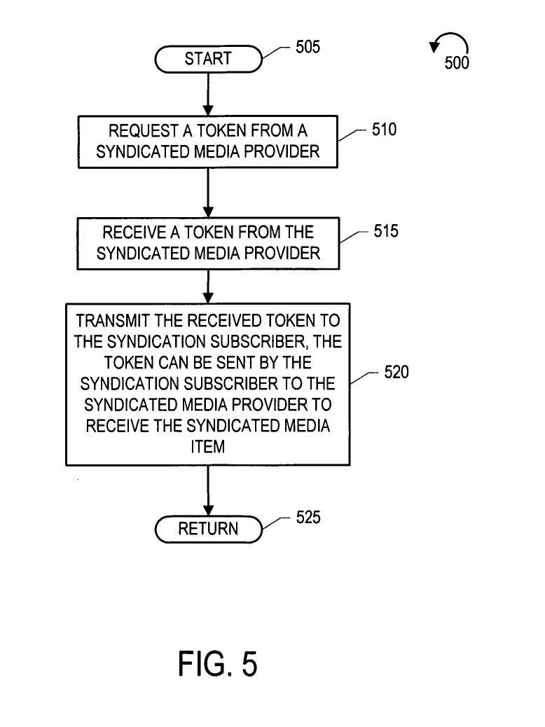

FIG. 5 illustrates another authorization method 500, which can be implemented as step 325 of FIG. 3. Method 500 starts in step 505. Then, in step 510, the authorization computer 105 requests a token from a syndicated media provider 120. Following step 510, in step 515, the authorization computer 105 receives a token from the syndicated media provider 120. Since the token is received from the syndicated media provider, the syndicated media provider knows which media item is associated with the token. Following step 515 in step 520, the authorization computer 105 transmits the received token to the syndicated media subscriber 110. The syndicated media subscriber 110 can then use the token to contact the syndicated media provider 120 and receive the syndicated media item. Then method 500 returns in step 525, for example to method 300 of FIG. 3.

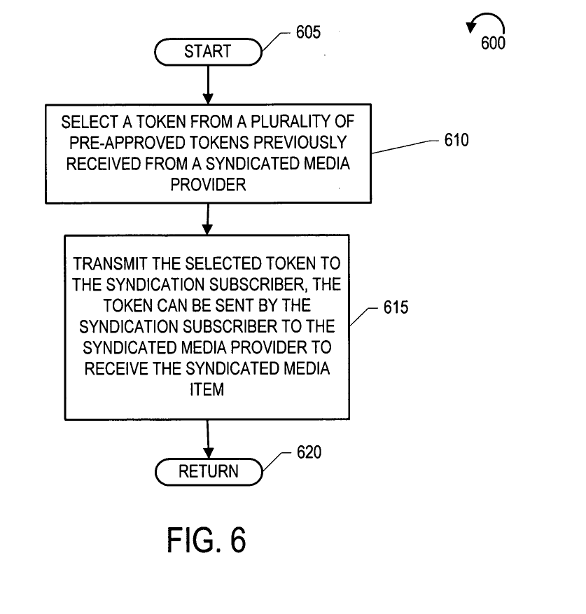

FIG. 6 illustrates another authorization method 600, which can be implemented as step 325 of FIG. 3. Method 600 starts in step 605. Then in step 610, the authorization computer 105 selects a token from a plurality of pre-approved tokens previously received from the syndication media provider 120. Then, in step 615 the selected token is transmitted to the syndication subscriber 110. The syndication subscriber can then use the token to obtain the syndicated media. Since the authorization computer 105 received the pre-approved tokens from the syndicated media provider 120, the syndicated media provider knows which media item is associated with the token. Then method 600 returns in step 620, for example to method 300 of FIG. 3.

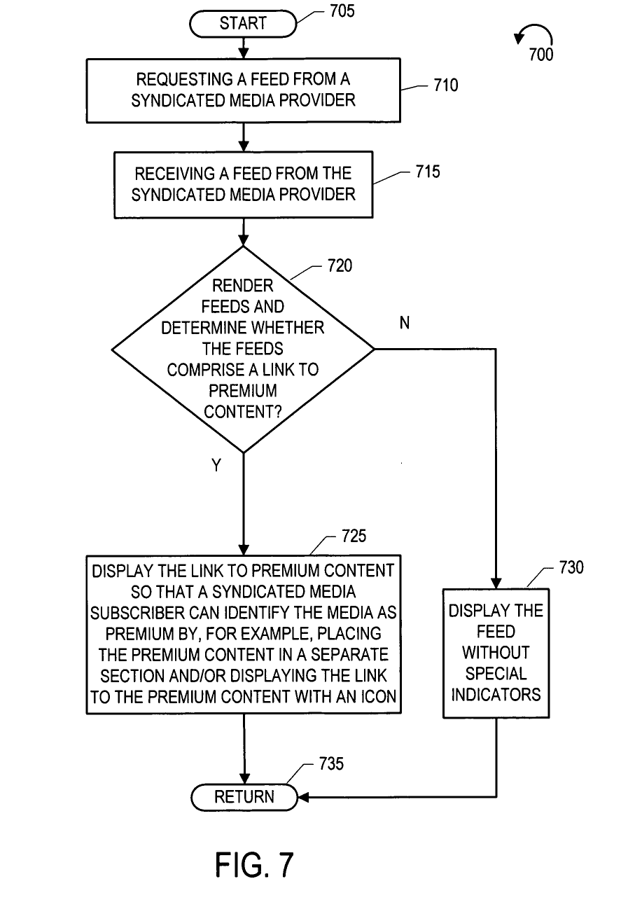

FIG. 7 illustrates a syndicated media aggregation method 700 that can be executed by the aggregator 130 of FIG. 1 or the aggregator 237 of FIG. 2. Method 700 starts in step 705. Then, method 700 proceeds to step 710 where the aggregator 237 requests a feed from a syndicated media provider. Depending on the number of feeds subscribed to by the syndicated media subscriber the aggregator 237 repeats step 710 to obtain all the information subscribed to by the user. In step 715 the aggregator 237 receives the feeds requested from the various syndicated media providers.

Then, in step 720 the aggregator 237 renders the feeds received from the various syndicated media providers in a form that is visually accessible to a user. As the aggregator 237 renders the feeds it determines whether a link in those feeds is a link to premium media. In one embodiment, the aggregator 237 can pick out links to premium content because it finds a link to an authorization computer and/or a link to an encrypted media file instead of a direct link to the media item itself. In one embodiment, the aggregator 237 can pick out links to limited use media items whether or not they are premium media items or not.

In step 720, if the aggregator 237 determines that the link is not to premium media, then method 700 proceeds to step 730, where the aggregator 237 displays the link to the syndicated media subscriber without any special indicators. Then, in step 735, method 700 returns to step 720, unless all the feeds are fully rendered.

Returning to step 720, if the aggregator 237 determines that the link is to premium media, then method 700 proceeds to step 725 where the aggregator 237 displays the link to the premium media so that the syndicated media subscriber can identify the media as premium. For example, the aggregator can place the premium media links in a separate section and/or the aggregator 237 can display the link to premium media with an identifying icon. In one embodiment, the aggregator 237 can display the limited use URLS with an identifying icon and/or icons identifying the number of uses left for a particular limited use media item. Then, in step 735, method 700 returns to step 720, unless all the feeds are fully rendered.

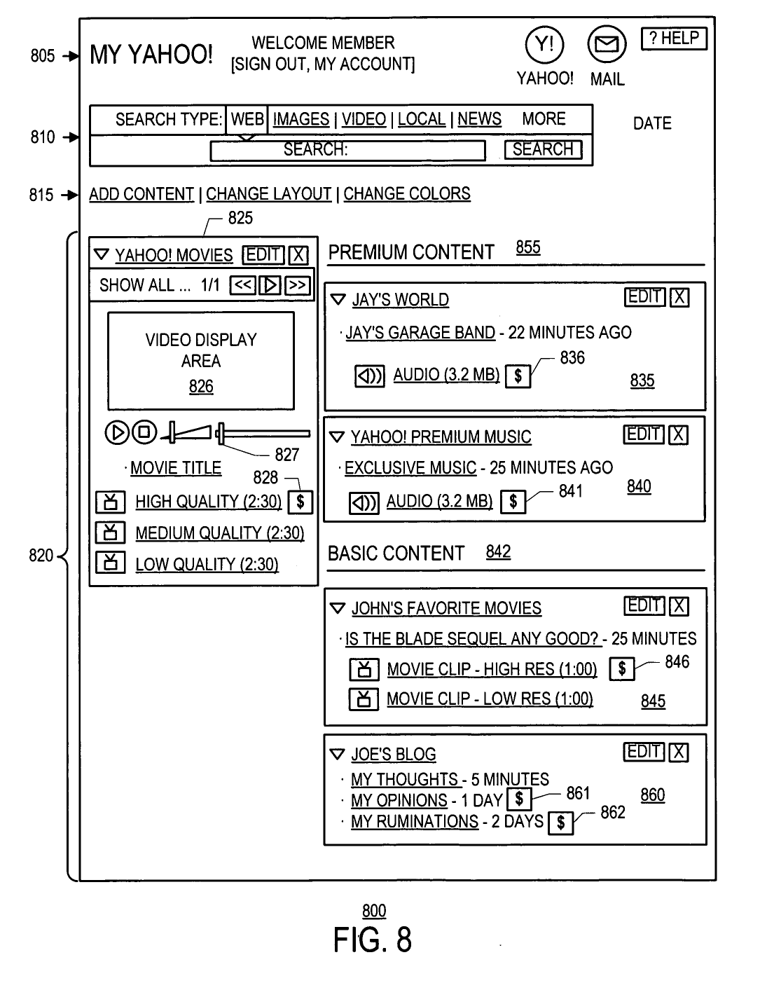

FIG. 8 illustrates an exemplary web page 800 that can be, in one embodiment, the electronic document 205 of FIG. 2. The syndicated media webpage 800 comprises a title area 805, a search area 810, a controls area 815 and a display area 820. The title area comprises the name of the page, the name of the syndication subscriber, a link to the network content provider and a link to obtain help. The search area 810 can be used by the user to initiate a search. The control area 815 can be used to add content, change the layout, and change colors within the webpage 800.

Display area 820 comprises a plurality of modules that display the information contained in feeds subscribed to by the user. For example, module 825 comprises rendering of a feed from a movie site. The module 825 comprises a video display are 826, and video controls 827. The movie clip accessible through the feed comes in three quality levels. As indicated by icon 828, only the high quality video requires authorization to access. Medium or low quality clips can be accessed for free.

Display area 820 also comprises a premium content section 855 and a basic content section 842. In one embodiment, the premium content section 855 comprises those feeds which only comprise for-pay media items while basic content section 842 comprises feeds that have either paid or free media items. In one embodiment, the premium content section 855 can comprise all feeds with any for-pay media items, while the basic content section 842 comprises renderings of feeds with only free contact. In one embodiment a content provider may pay extra to be placed in the premium content section 855. For example, user can set their personal page to only show section 855 or only show section 842.

In the premium content section 855, module 835 comprises a rendering of a feed from an exemplary site called, in this example, Jay's World. Jay's World provides audio content for a fee as indicated by icon 836 and its placement in section 855. Module 840 comprises premium music from Yahoo!, which can be music exclusively available through Yahoo! Icon 841 indicated that this is premium content.

In the basic content section 842, module 845 is a rendering of another example of a feed, this from John's Favorite Movies. This rendering has both free and premium content. An icon 846 is displayed adjacent to the link to the high resolution movie clip to indicate to a user that this media item requires payment or some other authorization. The link to the low resolution movie clip does not have an indicator, therefore it is free to be accessed by anyone without authorization. Module 860 comprises a rendering of a blog. In Joe's blog the latest blog are free but blogs of past days require a payment as indicated by icons 861 and 862. In this way the blogger can encourage people not to miss his latest post for free and the blogger can use a commercial RSS scheme to obtain payments for his past blogs.

In one embodiment, free items can also comprise indicators indicating that they are free. In one embodiment, different media items may have different cost. Thus, in one embodiment, the icons can include a price, and in one embodiment, the price can be displayed in a tooltip or other window, sub-window or dialog box that appears or pops up or slides in when a user hovers over the premium media identifiers.

While the description of the various embodiments of the disclosure are described in a server/client network environment, alternate embodiments of the disclosure can be performed in a peer-to-peer network or other interconnectivity schemes now known or hereafter to become known. For example, while media content providers have been described above as a server, in one embodiment, the media content provider can be another syndicated media subscriber in a peer to peer network. When a subscriber acts as a provider, it can have operations and routines loaded on the subscriber's computer that allow it to contact an authorization computer and receive authorization before the subscriber who is acting as a provider sends a media item to another subscriber.

While there have been shown and described and pointed out fundamental novel features of the disclosure as applied to preferred embodiments thereof, it will be understood that various omissions and substitutions and changes in the form and detail of the disclosed disclosure may be made by those skilled in the art without departing from the spirit of the disclosure. Thus features, functions or elements depicted or described as software or hardware can be implemented in a variety of ways, as either software, firmware or hardware or combinations thereof, and elements or subelements can be implemented as stand-alone or combined into multi-function elements, or be distributed across a network, as for example by implementation across client and server computers or combinations or individual units thereof, in manners now known or to become known. It is the intention, therefore, to be limited only as indicated by the scope of the claims appended hereto.

What is claimed:

1. A method of authorizing a syndicated media provider to send a limited use syndicated media item to a syndication subscriber, the method comprising:
receiving a first message from the syndication subscriber, the first message comprising a syndication subscriber identifier and a syndicated media item identifier that identifies the limited use syndicated media item, the syndication subscriber receiving the limited use syndicated media item identifier using a syndication retriever that periodically requests updates from a syndicated content provider;
determining whether the syndication subscriber is authorized to receive the limited use syndicated media item identified by the syndicated media identifier; and
in response to a positive determination of authorization, authorizing the communication of the limited use syndicated media item to the syndication subscriber.

2. The method of claim 1 further comprising the step of determining whether a threshold value associated with the limited use syndicated media item has been reached, wherein if the threshold value has been reached, the extent of data associated with the limited use media item that is made available to the syndication subscriber is affected, and if not reached, the extent is not limited.

3. The method of claim 1, wherein the syndicated subscriber obtains the syndicated media item identifier from an indicator in a syndication feed that can be resolved to retrieve the syndicated media item.

4. The method of claim 3, wherein the indicator is a URL to the syndicated media provider.

5. The method of claim 3, wherein the indicator is a URL to an authorization computer.

6. The method of claim 5, wherein the authorization computer is the syndicated media provider.

7. The method of claim 1, further comprising decrementing a counter stored in a memory if the threshold is not reached.

8. The method of claim 1, further comprising, in response to a negative determination of authorization, transmitting instructions to obtain the limited use syndicated media item to the syndication subscriber.

9. The method of claim 1, wherein the syndication retriever is a syndication aggregator.

10. The method of claim 1, further comprising transmitting the limited use syndicated media item to the syndication subscriber.

11. The method of claim 1, wherein the step of authorizing the transmission of the limited use syndicated media item to the syndication subscriber comprises:
transmitting a first token to the syndication subscriber, wherein the first token can be sent by the syndication subscriber to the syndicated media provider to receive the syndicated media item;
receiving a second token from the syndicated media provider; and
in response to a positive correlation between the first and second tokens, transmitting a second message to the syndicated media provider, the second message comprising an indication of authorization to send the limited use syndicated media item to the syndication subscriber.

12. The method of claim 11, wherein the indication of authorization is a universal resource identifier that identifies the limited use syndicated media item.

13. The method of claim 11, wherein the first token and the second token are the same token.

14. The method of claim 11, wherein the first token is a nonce.

15. The method of claim 11, wherein the first token provides access to the limited use syndicated media for a period of time.

16. The method of claim 11, wherein the first token provides access to the limited use syndicated media for a predetermined number of times.

17. The method of claim 1, wherein the step of authorizing the transmission of the limited use syndicated media item to the syndication subscriber comprises:
requesting a token from the syndicated media provider; and
transmitting the token to the syndication subscriber, wherein the token can be sent by the syndication subscriber to the syndicated media provider to receive the limited use syndicated media item.

18. The method of claim 1, wherein the step of authorizing the transmission of the limited use syndicated media item to the syndication subscriber comprises:
selecting a token from a plurality of pre-approved tokens previously received from the syndicated media provider; and
transmitting the token to the syndication subscriber, wherein the token can be sent by the syndication subscriber to the syndicated media provider to receive the limited use syndicated media item.

19. The method of clam 1, further comprising crediting an owner of the limited use syndicated media item.

20. The method of claim 1, wherein the step of determining whether the syndication subscriber is authorized to receive the limited use syndicated media item comprises determining whether the syndication subscriber has viewed a predetermined number of commercials.

21. The method of claim 1, wherein the step of determining whether the syndication subscriber is authorized to receive the limited use syndicated media item comprises determining whether the subscriber belongs to another service.

22. The method of claim 21, wherein the step of determining whether the subscriber belongs to another service comprises:
requesting from a network content provider the syndication subscriber's membership status in one or more services; and
receiving a response comprising the syndication subscriber's membership status in the one or more services.

23. The method of claim 1, wherein a positive determination of authorization is made if the subscriber can pay for the limited use syndicated media item.

24. The method of claim 1, wherein the step of determining whether the syndication subscriber is authorized to receive the limited use syndicated media item further comprises:
requesting a subscriber payment status from a network content provider; and
receiving a response comprising the syndication subscriber's payment status.

25. The method of claim 24, wherein an authorization computer and the network content provider are operated by different entities.

26. The method of claim 22, further comprising, in response to a negative determination of authorization, requesting payment from the syndication subscriber.

27. The method of claim 22, wherein the syndication subscriber guarantees payment through a credit card.

28. The method of claim 22, further comprising debiting a stored value account associated with the syndication subscriber.

29. The method of claim 1, wherein the step of determining whether the syndication subscriber is authorized to receive the limited use syndicated media item further comprises:
accessing a user database;
using the syndication subscriber identifier to find a subscriber's information on the user database; and
using the syndicated media identifier to determine from the subscriber's information whether the user is authorized to receive the limited use syndicated media item.

30. The method of claim 1, wherein the step of determining whether the syndication subscriber is authorized to receive the limited use syndicated media item comprises determining whether a syndication subscriber's subscription is in good standing.

31. The method of claim 1, wherein the syndicated media provider, performs the step of determining whether the syndication subscriber is authorized to receive the limited use syndicated media item identified by the syndicated media identifier.

32. The method of claim 1, wherein the step of determining whether a threshold value associated with the limited use syndicated media item has been reached comprises:
accessing a counter that represents a number of times the limited use syndicated media item has been accessed by said syndication subscriber; and
comparing the number of times the limited use syndicated media item has been accessed to the threshold value.

33. The method of claim 32 wherein if the number of times the limited use syndicated media item has been accessed exceeds the threshold value, the extent of the data displayed is limited.

34. The method of claim 33 wherein the limited data displayed comprises a message indicating that the threshold value has been reached.

35. The method of claim 33 wherein the limited data displayed comprises a portion of the data associated with the limited use syndicated media item.

36. The method of claim 33 wherein the portion comprises a clip.

37. The method of claim 1, wherein the syndicated media provider is another syndication subscriber.

38. The method of claim 1, wherein the limited use syndicated media item is syndicated using a real simple syndication protocol.

39. The method of claim 1, wherein the syndication aggregator is operated by a network content provider.

40. The method of claim 1, wherein the syndication aggregator is operated by the syndication subscriber.

41. The method of claim 1, wherein the syndicated media provider performs the step of authorizing the transmission of the limited use syndicated media item to the syndication subscriber.

42. The method of claim 1, wherein the limited use syndicated media is a video.

43. The method of claim 1, wherein the limited use syndicated media is part of a podcast.

44. The method of claim 1, wherein the limited use syndicated media is a blog.

45. The method of claim 1, wherein the limited use syndicated media is an audio file.

46. The method of claim 1, wherein the limited use syndicated media is computer code.

47. A method of displaying a syndication feed to a syndication subscriber, the method comprising:
examining the syndication feed to determine whether a link to a media item is a link to a limited use media item, the syndication subscriber requires authorization to receive the limited use media item; and
differentiating the link to the limited use media item from a link to an unlimited use media item when displaying the syndication feed to the syndication subscriber.

48. The method of claim 47, wherein the link to the limited use media is differentiated from the link to an unlimited use media item by placing the feed in a section dedicated to limited use content.

49. The method of claim 47, wherein the link to the limited use media is differentiated from the link to an unlimited use media item by displaying an icon adjacent to the link to the limited use media item.

50. The method of claim 47, wherein the link to a limited use media item is provided in an <enclosure> subelement of the syndication feed.

51. The method of claim 47, wherein the link to an authorization website further comprises a limited use media item identifier.
